(19) United States
(12) Patent Application Publication
(10) Pub. No.: US 2001/0001275 A1
(43) Pub. Date: May 17, 2001

(54) Shaping lathe tool

(76) Inventors: Eugen Maurer, Ober-Morlen (DE); Horst Lach, Hanau (DE)

Correspondence Address: LARSON & TAYLOR, PLC, 1199 NORTH FAIRFAX STREET, SUITE 900, ALEXANDRIA, VA, 22314, US

(21) Appl. No.: 09/736,402

(22) Filed: Dec. 15, 2000

(30) Foreign Application Priority Data
Aug. 10, 1999 (DE) 199 37 738.3

(51) Int. Cl. B23B 27/06; B23B 27/00

(52) U.S. Cl. 407/117; 407/109

(57) ABSTRACT

The shaping lathe tool, in particular for processing wheel rims made of a light alloy, consists of a rod-shaped holder (10) with a V-shaped longitudinal groove (28) for receiving a cutting insert (12) with a rounded cutter head (18), and a claw (16) which clamps the cutting insert (12) to the holder (10) and is fixed in place on the latter by means of a key and slot engagement (30) arranged parallel with the V-shaped groove (28) and a clamping screw. The front end (38) of the claw (16) is designed as a chip breaker. To provide a tool which resists extreme stresses, the cutting insert (12) is clampingly held in a V-shaped longitudinal groove (28) over a length of at least eight times the head radius, and is interlockingly fixed in place in the longitudinal direction by stop faces (22) extending normally in respect to the longitudinal direction of the groove.

1. The invention relates to a shaping lathe tool for rough forming and finishing of circumferential and flat surfaces, in particular of work pieces made of a light alloy, consisting of a rod-shaped holder with a V-shaped longitudinal groove at the front end for receiving an elongated cutting insert with a rounded cutter head, whose cutting edge, which consists of an extremely hard material, for example diamond or cubic boron nitride, extends over a circumferential angle of more than 90°, and a claw, which clamps the cutting insert to the holder, is fixed in place on the latter by means of a key and slot engagement arranged parallel with the V-shaped groove, and a clamping screw, and whose front end is designed as a chip breaker.

2. Shaping lathe tools of the type mentioned are used, for example, for processing the well-base of light alloy wheel rims for motor vehicles. The circumferential and flat surfaces on both sides, which transition into each other, are rough formed and finished with the same tool. Extreme loads from directions alternating over a range of more than 180° occur on the rounded cutter head in the course of rough finishing with a chip depth of up to 5 mm and at high cutting speeds. Under these stresses, hard alloy tools are worn out after processing 200 rims, i.e. the tools must be replaced twice per shift. Tools with a cutting insert made of polycrystalline diamond or boron nitride have long service lives, but up to now could not be stressed this much, because the clamped cutting insert began to vibrate and broke.

3. The object of the invention is based on improving a shaping lathe tool of the type identified above in such a way that it can sustain the mentioned stresses, and for attaining this object it is proposed by the invention that the cutting insert is clampingly held in the V-shaped longitudinal groove over a length of at least eight times the head radius, and is interlockingly fixed in place in the longitudinal direction by stop faces extending normally in respect to the longitudinal direction of the groove, and that the claw and/or the cutting insert at the surfaces oriented toward each other are set back behind a front contact area.

4. The stated goal is achieved with the novel shaping lathe tool by a combination of steps. Tilting moments can be better absorbed because of the increased length of the cutting insert. The latter is interlockingly fixed in place not only in transverse direction by the V-guide, but also additionally in the longitudinal direction, so that one need not have to support only frictionally the forces in the longitudinal direction, which because of the rounded cutter head are very high. Finally, because of setting back the clamping surface of the claw and/or the opposite surface on the side of the cutting insert behind a front contact area, it its provided that a high clamping pressure is achieved directly at or behind the cutter head.

5. In a cost-effective embodiment, the interlocking support of the cutting insert in the longitudinal direction is preferably achieved in that it is provided with a transverse groove, which is engaged by a pin seated in the longitudinal groove in the holder.

6. In a further preferred embodiment of the invention, the screw hole for the clamping screw in the claw is large enough so that the latter can be adjusted in the longitudinal direction to a certain extent.

7. An exemplary embodiment of the invention will be explained in greater detail in what follows by means of the drawings. Shown are in:

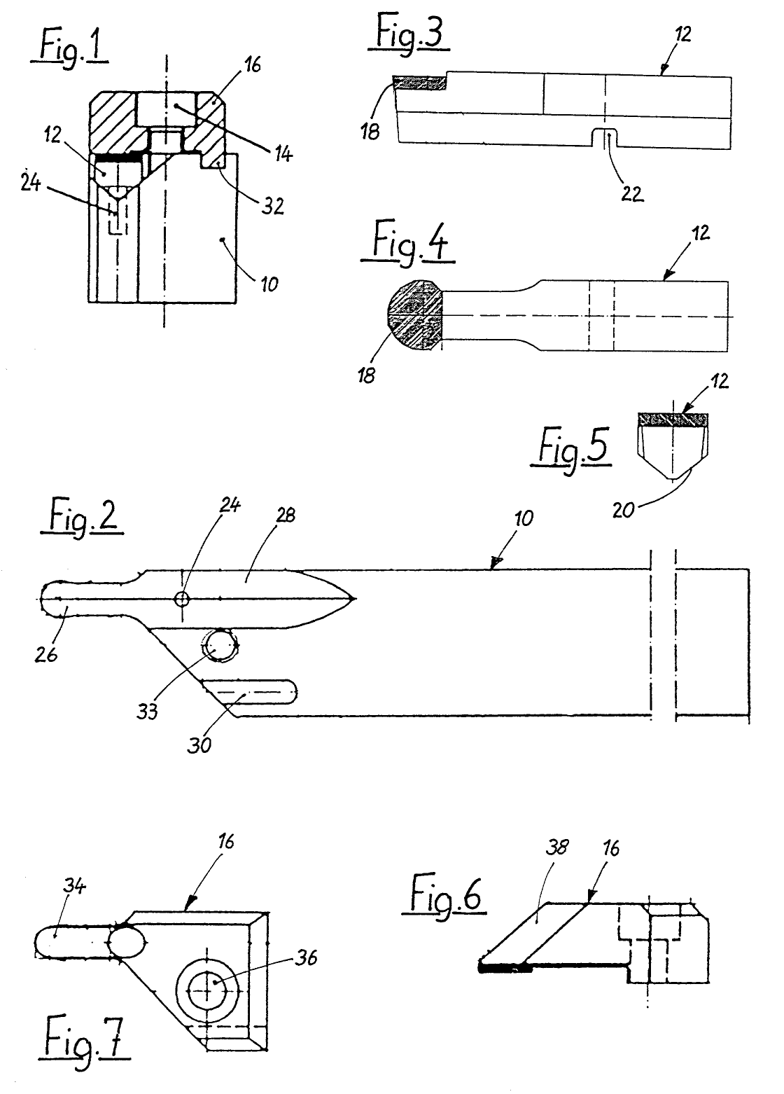

8. FIG. 1, a cross section through a shaping lathe tool, whose individual parts are represented in the subsequent figures,

9. FIG. 2, a top plan view on the essentially shaft- or rod-shaped holder of the shaping lathe tool in accordance with FIG. 1,

10. FIGS. 3, 4 and 5, lateral, top plan and front plan views of the cutting insert of the shaping lathe tool in accordance with FIG. 1,

11. FIGS. 6 and 7, a lateral and a top plan view of the claw of the shaping lathe tool in accordance with FIG. 1.

12. A shaping lathe tool is represented in the assembled state in FIG. 1. It essentially consists of a shaft- or rod-shaped holder 10, on whose front end a cutting insert 12 is clamped in place by a claw 16, which can be clamped by means of a clamping screw 14.

13. The cutting insert 12 represented in FIGS. 3 to 5 basically has a known, elongated shape with a cutter head 18 at the front end and an underside 20, which is essentially V-shaped in cross section. The cutting insert 12 has for example a length of 40 mm, a height of 7.6 mm and a greatest width of 8 mm. The rounded cutter head 18 has a diameter of 8 mm. The circular cutting edge extends over more than 180°, so that it is possible to work circumferential surfaces, as well as flat surfaces adjoining these at both sides, with this cutting insert 12. For this purpose the width of the cutting insert 12 is less in the area behind the cutter head 18 than the diameter of the latter, and the cutter head 18 is chamfered toward the rear. In the case of the example, the cutting edge is constituted by a polycrystalline diamond (PCD), wherein the diamond layer is fixedly connected in the customary manner with a substrate of a hard alloy, which in turn has been soldered to the shaft of the cutting insert 12.

14. It is uncommon in connection with the cutting insert 12 represented that, with a diameter of the cutter head 18 made of PCD of 8 mm, the length of the cutting insert is 40 mm, i.e. is more than twice as long than such cutting inserts customary up to now. A further special feature consists in that the shaft of the cutting insert 12, which is provided with an essentially V-shaped underside over its entire length, has been provided in the center area with a transverse groove 22 on the underside. A pin 24, represented in FIGS. 1 and 2, engages this groove and interlockingly holds the cutting insert 12 in the clamped state.

15. In its rear area, the top plan view on the holder 10 in accordance with FIG. 2 shows a shaft with a square cross section and a length of 25 mm at the edges. In the case of the example, the total length of the holder 10 is 160 mm. Its front end on one side has a forward projecting protrusion 26, on which the front end of the cutting insert 12 rests. On the other side the holder 10 is chamfered toward the rear, starting at the protrusion. A V-guide 28 matching the V-shaped underside of the cutting insert 12, extends along the protrusion 26 and adjoining the protrusion 26 further toward the rear over a total length of approximately 42 mm. In this case the position of the pin 24 has been selected to be such that, when engaging the transverse groove 22, the cutter head 18 rests on the protrusion 26 and is thus supported.

16. On the other side of the holder 10 shown in FIG. 2 a further guide groove 30 is situated, which is rectangular in cross section in the case of the example and is intended to be engaged by a linear rib 32 on the underside of the claw 16, as can be seen in FIG. 1. A threaded bore 33 is provided in the top of the holder 10 between the linear groove 30 and the V-guide 28, into which the clamping screw 14 of the claw 16 can be screwed.

17. The claw 16 represented in FIGS. 5 and 6 also has a forward projecting protrusion 34 on the front end, which is followed in the rear by an element, which is almost as wide as the holder 10. A through hole 36, through which the clamping screw 14 extends, is located in this wide area between the cutting insert 12 in the clamped state and the linear rib 32. The diameters of this threaded hole 36 are slightly larger than the head diameter and the shaft diameter of the clamping screw 14, so that in a slightly clamped state in accordance with FIG. 1 the claw 16, whose protrusion 34 simultaneously constitutes a chip breaker, can be pushed slightly forward or back in order to be able to set the chip breaker to the respectively optimal distance from the front end of the cutting edge of the cutter head 18. In the case of the example, the front end of the protrusion 34 of the claw 16, used as a chip breaker, is formed by a round rod made of hard alloy, having a diameter of 5 mm, for example, which rises obliquely from the front bottom to the rear top. This hard alloy rod has been soldered into a seat, which has been machined out and is identified by 38 in the drawings.

18. A special feature of the claw 16 consists in that its underside is recessed, for example by 0.5 mm, in the area where it rests on the cutting insert 12, i.e. on the underside of the protrusion 34 behind a contact area of 9 mm length, for example. It is achieved by this that a high clamping force is obtained by the clamping pressure generated when the clamping screw 14 is tightened, primarily at the very front, where the claw 16 presses on the cutter head 18 and the contact area behind it. Vibrations of the front end of the cutting insert 12 are effectively prevented by this.

19. It is understood that the holder 10 and the claw 16 can also have different shapes matched to each other, as long as the above mentioned objectives are achieved to about the same extent as with the represented embodiment.

1. A shaping lathe tool for rough forming and finishing of circumferential and flat surfaces, in particular of work pieces made of a light alloy, consisting of a rod-shaped holder (10) with a V-shaped longitudinal groove (28) at the front end for receiving an elongated cutting insert (12) with a rounded cutter head (18), whose cutting edge, which consists of an extremely hard material, for example diamond or cubic boron nitride, extends over a circumferential angle of more than 90°, and a claw (16), which clamps the cutting insert (12) to the holder (10), is fixed in place on the latter by means of a key and slot engagement (30, 32) arranged parallel with the V-shaped groove (28) and a clamping screw (14), and whose front end (38) is designed as a chip breaker, characterized in that the cutting insert (12) is clampingly held in the V-shaped longitudinal groove (28) over a length of at least eight times the head radius and is interlockingly fixed in place in the longitudinal direction by stop faces (22, 24) extending normally in respect to the longitudinal direction of the groove, and that the claw (16) and/or the cutting insert (12) at the surfaces oriented toward each other are set back behind a front contact area.

2. The shaping lathe tool in accordance with claim 1, characterized in that the cutting insert (12) is interlockingly held in the longitudinal direction by means of a transverse groove (22), which is engaged by a pin (24) seated in the longitudinal groove (28) in the holder (10).

3. The shaping lathe tool in accordance with claim 1, characterized in that the cutting insert (12) has a height and width of approximately twice the radius of the cutter head (18).

4. The shaping lathe tool in accordance with claim 1, characterized in that the threaded hole (36) for the clamping screw (14) in the claw (16) is sufficiently large so that the latter can be adjusted in the longitudinal direction to a certain extent.

5. The shaping lathe tool in accordance with claim 1, characterized in that the key and slot engagement (30, 32) consists of a longitudinal rib (32) of a semicircular cross section, arranged on the underside of the claw (16), and a second V-shaped linear groove (30) arranged on the holder (10).
